(19) United States
(12) Patent Application Publication
(10) Pub. No.: US 2026/0131319 A1
(43) Pub. Date: May 14, 2026

(54) PROCESS FOR THE PRODUCTION OF AEI-TYPE ZEOLITIC MATERIALS HAVING A DEFINED MORPHOLOGY

(71) Applicant: BASF SE, Ludwigshafen am Rhein (DE)

(72) Inventors: Trees Maria DE BAERDEMAEKER, Ludwigshafen am Rhein (DE); Andrei-Nicolae PARVULESCU, Ludwigshafen am Rhein (DE); Ulrich MUELLER, Neustadt (DE); Toshiyuki YOKOI, Tokyo (JP); Hermann GIES, Bochum (DE); Raquel SIMANCAS, Tokyo (JP)

(21) Appl. No.: 18/706,864

(22) PCT Filed: Oct. 31, 2022
(86) PCT No.: PCT/EP2022/080360

§ 371 Date: May 2, 2024

(30) Foreign Application Priority Data
Nov. 2, 2021 (EP) 21206022.2

(51) Int. Cl. B01J 29/86; B01D 53/94; B01J 37/03; B01J 37/04; C01B 39/48

(52) U.S. Cl. CPC B01J 29/86; B01D 53/9418; B01J 37/031; B01J 37/04; C01B 39/48; B01D 2255/50; B01D 2257/404; B01D 2258/012; C01P 2002/72; C01P 2004/03

(57) ABSTRACT

The present invention relates to a zeolitic material having an AEI-type framework structure comprising SiO2, Al2O3 and B2O3, wherein the Al:B molar ratio of the zeolitic material, is comprised in the range of from 3 to 500, and wherein the zeolitic material displays an Si:(Al+B) molar ratio of the zeolitic material, which is comprised in the range of from 2 to 11. The present invention also relates to a process for the preparation of the zeolitic material according to the present invention, to a process for the treatment of NOx by selective catalytic reduction and to an apparatus for the treatment of a gas stream containing NOx, as well as to the use of a zeolitic material according to the present invention.

### TECHNICAL FIELD

The present invention relates to a zeolitic material having an AEI-type framework structure comprising SiO₂, Al₂O₃ and B₂O₃, as well as to a process for the preparation of the zeolitic material according to the present invention, to a process for the treatment of NOₓ by selective catalytic reduction and to an apparatus for the treatment of a gas stream containing NON, as well as to the use of a zeolitic material according to the present invention.

### Introduction

Small pore zeolitic materials such as those of the AEI framework type are known to be potentially effective as catalysts or catalyst components for treating combustion exhaust gas in industrial applications, for example for converting nitrogen oxides (NOₓ) in an exhaust gas stream. Synthetic AEI zeolitic materials are generally produced by precipitating crystals of the zeolitic material from a synthesis mixture which contains the sources of the elements from which the zeolitic framework is built, such as a source of silicon and a source of aluminum. An alternative approach may be the preparation via zeolitic framework conversion according to which a starting material which is a suitable zeolitic material having a framework type other than AEI is suitably reacted to obtain the zeolitic material having framework type AEI.

Zeolitic materials are however highly versatile and known to find broad applications, in particular in catalytic applications.

In view of the decreasing amount of oil reserves which constitute the raw material for the production of short-chain hydrocarbons and derivatives thereof, alternative processes for the production of such base chemicals are of a growing importance. In such alternative processes for the production of short-chain hydrocarbons and derivatives thereof, often highly specific catalysts are used therein for converting other raw materials and/or chemicals to hydrocarbons and their derivatives such as in particular short-chain olefins. A particular challenge involved in such processes not only relies in the optimal choice of reaction parameters but, more importantly, in the use of particular catalysts allowing for the highly efficient and selective conversion to a desired hydrocarbon or derivative thereof such as in particular olefinic fractions. In this respect, processes in which methanol is employed as the starting material, are of particular importance, wherein their catalytic conversion usually leads to a mixture of hydrocarbons and derivatives thereof, in particular olefins, paraffins, and aromatics.

Thus, the particular challenge in such catalytic conversions resides in the optimization and the fine tuning of the catalysts (particularly the zeolite pore structure, acid type and strength) employed as well as the process architecture and parameters such that a high selectivity towards as few products as possible may be achieved. For this reason, such processes are often named after the products for which a particularly high selectivity may be achieved in the process. Accordingly, processes which have been developed in the past decades towards the conversion of oxygenates to olefins and in particular of methanol to olefins which have gained increasing importance in view of dwindling oil reserves are accordingly designated as methanol-to-olefin-processes (MTO-processes for methanol to olefins).

Among the catalytic materials which have been found for use in such conversions, zeolitic materials have proven of high efficiency, wherein in particular zeolitic materials of the pentasil-type and more specifically those having an MFI- and MEL-type framework structures including such zeolites displaying an MFI-MEL-intergrowth type framework structure are employed. On the other hand, U.S. Pat. No. 5,958,370 which relates to the production of SSZ-39 having the AEI type framework structure also describes their use in the catalytic conversion of methanol to olefins. Thus, U.S. Pat. No. 5,958,370 relates to SSZ-39 and to its preparation using cyclic or polycyclic quaternary ammonium cations as templating agent.

Moliner, M. et al. in Chem. Commun. 2012, 48, pages 8264-8266, on the other hand, concerns Cu-SSZ-39 and its use for the SCR of nitrogen oxides NOx, wherein the SSZ-39 is produced with the use of N,N-dimethyl-3,5-dimethylpiperidinium cations as the organotemplate. Maruo, T. et al. in Chem. Lett. 2014, 43, page 302-304 relates to the synthesis of AEI zeolites by hydrothermal conversion of FAU zeolites in the presence of tetraethylphosphonium cations. Martin, N. et al. in Chem. Commun. 2015, 51, 11030-11033 concerns the synthesis of Cu-SSZ-39 and its use as a catalyst in the SCR of nitrogen oxides NOx. As regards the methods of synthesis of the SSZ-39 zeolite in said document, these include the use of N,N-dimethyl-3,5-dimethylpiperidinium cations as well as of tetraethylphosphonium cations. Dusselier, M. et al. in ACS Catal. 2015, 5, 10, 6078-6085, on the other hand, describe methanol to olefin catalysis using hydrothermally treated SSZ-39.

US 2015/0118150 A1 describes zeolite synthesis methods involving the use of N,N-dimethyl-3,5-dimethylpiperidinium and N,N-dimethyl-2,6-dimethylpiperidinium cations, respectively. WO 2016/149234 A1 and Ransom, R. et al. in Ind. Eng. Chem. Res. 2017, 56, 4350-4356 respectively relate to the synthesis of SSZ-39 via interzeolitic conversion of faujasite using N,N-dimethyl-3,5-dimethylpiperidinium cations as the organotemplate. WO 2018/113566 A1, on the other hand, relates to the synthesis of zeolites via solvent-free interzeolitic conversion, wherein the synthesis of SSZ-39 from interzeolitic conversion of zeolite Y using N,N-dimethyl-2,6-dimethylpiperidinium cations is described.

JP 2018087105 relates to a boron-containing zeolitic material displaying the AEI-type framework structure which is prepared using tetraethylphosphonium as templating agent.

Despite the variety of methods known to the skilled person for the synthesis of small pore zeolites, there remains the need for methods leading to new and improved small pore zeolitic materials. In particular, there remains the need for synthesis methods allowing for a tailoring of the physical and chemical properties of small pore zeolitic materials in view of providing materials with novel properties leading to improved results in known applications and furthermore allowing for their use in novel applications.

### DETAILED DESCRIPTION

It was therefore the object of the present invention to provide an improved synthesis methodology for the production of small pore zeolitic materials with novel physical and chemical properties, in particular relative to their catalytic properties. Thus, it has surprisingly been found that by using a reaction mixture containing relatively low amounts of boron and a tetraalkylammonium cation as templating agent, AEI-type zeolitic materials displaying new and unexpected properties may be obtained. In particular, it has quite unexpectedly been found that by including relatively low amounts of boron into the reaction mixture in combination with a tetraalkylammonium cation as templating agent, the size of the primary crystals is surprisingly increased. As a result, the AEI-type zeolitic materials of the present invention display a substantially lower surface to volume ratio which leads to different physical and chemical properties of the resulting materials, in particular with regard to their catalytic properties. Furthermore, it has quite unexpectedly been found that the measure of the surprising technical effect of the invention is substantially proportional to the amount of boron which is used, without however influencing the total ratio of tetravalent elements Y to trivalent elements X in the framework structure, such that the physical and chemical properties of the resulting materials may be effectively be fine-tuned with a high precision. In particular, it has surprisingly been found that the technical effects of the present invention may be achieved with relatively low amounts of boron, such that the amount of catalytically active Al-sites in the framework structure of the resulting material remains high.

Therefore, the present invention therefore relates toa zeolitic material having an AEI-type framework structure comprising SiO₂, Al₂O₃ and B₂O₃, wherein the Al:B molar ratio of the zeolitic material, preferably of the framework structure of the zeolitic material, is comprised in the range of from 3 to 500, and wherein the zeolitic material displays an Si:(Al+B) molar ratio of the zeolitic material, preferably of the framework structure of the zeolitic material, which is comprised in the range of from 2 to 11.

It is preferred that the Al:B molar ratio of the zeolitic material, preferably of the framework structure of the zeolitic material, is in the range of from 5 to 200, preferably of from 8 to 100, more preferably of from 10 to 50, more preferably of from 11 to 35, more preferably of from 12 to 25, more preferably of from 13 to 20, and more preferably of from 15 to 16.

It is preferred that the Si:B molar ratio of the zeolitic material, preferably of the framework structure of the zeolitic material, is 30 or more, and is preferably in the range of from 40 to 2,000, preferably of from 50 to 1,200, more preferably of from 60 to 800, more preferably of from 70 to 500, more preferably of from 100 to 300, more preferably of from 150 to 250, and more preferably of from 180 to 220.

It is preferred that the Si:Al molar ratio of the zeolitic material, preferably of the framework structure of the zeolitic material, is in the range of from 2 to 500, preferably of from 3 to 200, more preferably of from 4 to 100, more preferably of from 5 to 50, more preferably of from 6 to 25, more preferably of from 7 to 20, more preferably of from 8 to 15, more preferably of from 9 to 12, and more preferably of from 10 to 11.

It is preferred that the Si:(Al+B) molar ratio of the zeolitic material, preferably of the framework structure of the zeolitic material, is in the range of from 4 to 10.5, preferably of from 5 to 10, more preferably of from 5.5 to 9.5, more preferably of from 6 to 9, more preferably of from 6.5 to 8.5, and more preferably of from 7 to 8.

It is preferred that the mean particle size of the primary crystals of the zeolitic material is in the range of from 0.5 to 4.0 μm, preferably of from 0.6 to 3.0 μm, more preferably of from 0.8 to 2.5 μm, more preferably of from 1.0 to 2.0 μm, more preferably of from 1.2 to 1.8 μm, and more preferably of from 1.4 to 1.6 μm, wherein the mean particle size of the primary crystals of the zeolitic material is preferably obtained according to the method of Reference Example 4.

It is preferred that the primary crystals of the zeolitic material display a mean aspect ratio of greater than 1.2, and preferably a mean aspect ratio in the range of from 1.3 to 6.0, more preferably from 1.4 to 5.0, more preferably from 1.5 to 4.5, more preferably from 2.0 to 4.0, and more preferably from 2.5 to 3.5, wherein the mean aspect ratio of the primary crystals of the zeolitic material is preferably obtained according to the method of Reference Example 4.

It is preferred that 95 or more weight-% of the framework of the zeolitic material consists of Si, Al, B, O, and H, calculated based on the total weight of the framework of the zeolitic material, preferably 95 to 100 weight-%, more preferably 97 to 100 weight-%, more preferably 99 to 100 weight-%.

It is preferred that the zeolitic material further contains one or more metals selected from the group consisting of alkali metals and alkaline earth metals at the ion-exchange sites of the framework structure, preferably one or more metals selected from the group consisting of Li, Na, K, Rb, Cs, Mg, and Ca, more preferably from the group consisting of Li, Na, and K, wherein more preferably the zeolitic material further contains K and/or Na, preferably Na, at the ion-exchange sites of the framework structure.

In case where the zeolitic material further contains one or more metals selected from the group consisting of alkali metals and alkaline earth metals at the ion-exchange sites of the framework structure, it is preferred that the zeolitic material further contains Mg, Ca, or Mg and Ca at the ion-exchange sites of the framework structure.

It is preferred that the zeolitic material comprises one or more metal cations M selected from the group consisting of Sr, Zr, Cr, Mo, Fe, Co, Ni, Cu, Zn, Ru, Rh, Pd, Ag, Os, Ir, Pt, Au, La, Ce, Pr, Nd, Sm, Eu, Gd, Tb, Dy, Ho, Er, Tm, Yb, Lu, Y, Sc, and mixtures of two or more thereof, preferably selected from the group consisting of Sr, Zr, Cr, Mo, Fe, Co, Ni, Cu, Zn, Ru, Rh, Pd, Ag, Os, Ir, Pt, Au, and mixtures of two or more thereof, more preferably from the group consisting of Sr, Cr, Mo, Fe, Co, Ni, Cu, Zn, Ag, and mixtures of two or more thereof, more preferably from the group consisting of Cr, Mo, Fe, Ni, Cu, Zn, Ag, and mixtures of two or more thereof, more preferably from the group consisting of Mo, Fe, Ni, Cu, Zn, Ag, and mixtures of two or more thereof, wherein more preferably the one or more cations M comprise Cu and/or Fe, preferably Cu, wherein even more preferably the one or more cations M consist of Cu and/or Fe, preferably of Cu, wherein the one or more metal cations M are preferably located at the ion-exchange sites of the framework structure of the zeolitic material.

In case where the zeolitic material comprises one or more metal cations M, it is preferred that the zeolitic material comprises the one or more metal cations M in an amount in the range of from 0.01 to 5 weight-% based on 100 weight-% of Si in the zeolitic material calculated as SiO₂, preferably in the range of from 0.05 to 4 weight-%, more preferably in the range of from 0.1 to 3 weight-%, more preferably in the range of from 0.2 to 2.5 weight-%, more preferably in the range of from 0.4 to 2 weight-%, more preferably in the range of from 0.6 to 1.5 weight-%, and more preferably in the range of from 0.8 to 1.2 weight-%.

In case where the zeolitic material comprises one or more metal cations M, it is further preferred that 95 or more weight-% of the zeolitic material consists of Si, Al, B, O, H, and the one or more metal cations M, calculated based on the total weight of the zeolitic material, preferably 95 to 100 weight-%, more preferably 97 to 100 weight-%, more preferably 99 to 100 weight-%.

It is preferred that the zeolitic material having an AEI-type framework structure is selected from the group consisting of SSZ-39, SAPO-18, and SIZ-8, including mixtures of two or more thereof, wherein preferably the zeolitic material comprises SSZ-39, and wherein more preferably the zeolitic material is SSZ-39.

It is preferred that the zeolitic material contains 5 wt.-% or less of phosphorous (P) calculated as the element and based on 100 wt.-% of SiO₂ contained in the zeolitic material, preferably 3 wt. % or less, more preferably 1 wt.-% or less, more preferably 0.5 wt.-% or less, more preferably 0.1 wt.-% or less, more preferably 0.05 wt.-% or less, more preferably 0.01 wt.-% or less, more preferably 0.005 wt.-% or less, more preferably 0.001 wt.-% or less, more preferably 0.0005 wt. % or less, and more preferably 0.0001 wt.-% or less.

The present invention also relates to a process for the preparation of a zeolitic material having an AEI-type framework structure comprising SiO₂, Al₂O₃ and B₂O₃, preferably of a zeolitic material according to any one of the particular and preferred embodiments of the present invention, the process comprising
(1) preparing a mixture comprising one or more organotemplates as structure directing agents, one or more sources of SiO₂, one or more sources of B₂O₃, one or more sources of Al₂O₃, optionally seed crystals, and a solvent system;
(2) heating the mixture obtained in (1) for crystallizing a zeolitic material comprising SiO₂, B₂O₃ and Al₂O₃ in its framework structure from the mixture;
wherein the one or more organotemplates comprises one or more tetraalkylammonium cation R¹R²R³R⁴N⁺-containing compounds, wherein R¹, R², R³ independently from one another stand for alkyl, and wherein R⁴ stands for alkyl or aryl.

It is preferred that the molar ratio of Si:B of the silicon to the boron, calculated as the element, respectively, in the mixture prepared according to (1) is in the range of from 1 to 80, preferably of from 2 to 50, more preferably of from 3 to 35, more preferably of from 4 to 25, more preferably of from 6 to 20, more preferably of from 8 to 18, and more preferably of from 10 to 15.

It is preferred that the molar ratio of Si:Al of the silicon to the aluminum, calculated as the element, respectively, in the mixture prepared according to (1) is in the range of from 1 to 300, preferably of from 3 to 200, more preferably of from 5 to 120, more preferably of from 10 to 80, more preferably of from 15 to 50, more preferably of from 20 to 35, and more preferably of from 25 to 30.

It is preferred that the molar ratio SiO₂:organotemplate of the one or more sources for SiO₂ to the one or more organotemplates in the mixture prepared in (1) is in the range of from 1 to 50, preferably of from 2 to 35, more preferably of from 3 to 25, more preferably of from 4 to 18, more preferably of from 5 to 12, more preferably of from 6 to 9, and more preferably of from 6.5 to 7.

It is preferred that R¹, R², R³ and R⁴ independently from one another stand for alkyl, and wherein R³ and R⁴ form a common alkyl chain.

In case where R¹, R², R³ and R⁴ independently from one another stand for alkyl, and wherein R³ and R⁴ form a common alkyl chain, it is preferred that R¹ and R² independently from one another stand for optionally branched (C₁-C₆)alkyl, preferably (C₁-C₅)alkyl, more preferably (C₁-C₄)alkyl, more preferably (C₁-C₃)alkyl, wherein more preferably R¹ and R² independently from one another stand for methyl or ethyl, and more preferably for methyl.

In case where R¹, R², R³ and R⁴ independently from one another stand for alkyl, and wherein R³ and R⁴ form a common alkyl chain, it is preferred that R³ and R⁴ form a common (C₄-C₈)alkyl chain, more preferably a common (C₄-C₇)alkyl chain, more preferably a common (C₄-C₆)alkyl chain, wherein more preferably said common alkyl chain is a C₄ or C₅ alkyl chain, and more preferably a C₅ alkyl chain.

Furthermore and independently thereof, it is preferred that the one or more tetraalkylammonium cation R¹R²R³R⁴N⁺-containing compounds comprise one or more ammonium compounds selected from the group consisting of NN-di(C₁-C₄)alkyl-3,5-di(C₁-C₄)alkylpyrrolidinium compounds, N,N-di(C₁-C₄)alkyl-3,5-di(C₁-C₄)alkylpiperidinium compounds, N,N-di(C₁-C₄)alkyl-3,5-di(C₁-C₄)alkylhexahydroazepinium compounds, N,N-di(C₁-C₄)alkyl-2,6-di(C₁-C₄)alkylpyrrolidinium compounds, N,N-di(C₁-C₄)alkyl-2,6-di(C₁-C₄)alkylpiperidinium compounds, N,N-di(C₁-C₄)alkyl-2,6-di(C₁-C₄)alkylhexahydroazepinium compounds, and mixtures of two or more thereof,
preferably from the group consisting of N,N-di(C₁-C₃)alkyl-3,5-di(C₁-C₃)alkylpyrrolidinium compounds, N,N-di(C₁-C₃)alkyl-3,5-di(C₁-C₃)alkylpiperidinium compounds, N,N-di(C₁-C₃)alkyl-3,5-di(C₁-C₃)alkylhexahydroazepinium compounds, N,N-di(C₁-C₃)alkyl-2,6-di(C₁-C₃)alkylpyrrolidinium compounds, N,N-di(C₁-C₃)alkyl-2,6-di(C₁-C₃)alkylpiperidinium compounds, N,N-di(C₁-C₃)alkyl-2,6-di(C₁-C₃)alkylhexahydroazepinium compounds, and mixtures of two or more thereof,
more preferably from the group consisting of N,N-di(C₁-C₂)alkyl-3,5-di(C₁-C₂)alkylpyrrolidinium compounds, N,N-di(C₁-C₂)alkyl-3,5-di(C₁-C₂)alkylpiperidinium compounds, N,N-di(C₁-C₂)alkyl-3,5-di(C₁-C₂)alkylhexahydroazepinium compounds, N,N-di(C₁-C₂)alkyl-2,6-di(C₁-C₂)alkylpyrrolidinium compounds, N,N-di(C₁-C₂)alkyl-2,6-di(C₁-C₂)alkylpiperidinium compounds, N,N-di(C₁-C₂)alkyl-2,6-di(C₁-C₂)alkylhexahydroazepinium compounds, and mixtures of two or more thereof,
more preferably from the group consisting of N,N-di(C₁-C₂)alkyl-3,5-di(C₁-C₂)alkylpiperidinium compounds, N,N-di(C₁-C₂)alkyl-2,6-di(C₁-C₂)alkylpiperidinium compounds, and mixtures of two or more thereof, wherein more preferably the one or more tetraalkylammonium cation R¹R²R³R⁴N⁺-containing compounds comprise one or more N,N-dimethyl-3,5-dimethylpiperidinium and/or N,N-diethyl-2,6-dimethylpiperidinium compounds, preferably one or more N,N-dimethyl-3,5-dimethylpiperidinium compounds.

Furthermore, it is preferred that the N,N-dialkyl-2,6-dialkylpyrrolidinium compounds, N,N-dialkyl-2,6-dialkylpiperidinium compounds, and/or N,N-dialkyl-2,6-dialkylhexahydroazepinium compounds display the cis configuration, the trans configuration, or contain a mixture of the cis and trans isomers,
wherein preferably the N,N-dialkyl-2,6-dialkylpyrrolidinium compounds, N,N-dialkyl-2,6-dialkylpiperidinium compounds, and/or N,N-dialkyl-2,6-dialkylhexahydroazepinium compounds display the cis configuration,
wherein more preferably the one or more tetraalkylammonium cation R¹R²R³R⁴N⁺-containing compounds comprise one or more ammonium compounds selected from the group consisting of N,N-di(C₁-C₂)alkyl-cis-2,6-di(C₁-C₂)alkylpiperidinium compounds, and mixtures of two or more thereof, wherein more preferably the one or more tetraalkylammonium cation R¹R²R³R⁴N⁺-containing compounds comprise one or more N,N-diethyl-cis-2,6-dimethylpiperidinium compounds.

It is preferred that the one or more organotemplates are provided as salts, preferably as one or more salts selected from the group consisting of halides, sulfate, nitrate, phosphate, acetate, and mixtures of two or more thereof, more preferably from the group consisting of bromide, chloride, hydroxide, sulfate, and mixtures of two or more thereof, wherein more preferably the one or more organotemplates are provided as hydroxides and/or bromides, and more preferably as hydroxides.

It is preferred that the mixture prepared in (1) comprises seed crystals, wherein the amount of seed crystals comprised in the mixture prepared in (1) is in the range of from 0.1 to 15 weight-% based on 100 weight-% of Si in the mixture calculated as SiO₂, and preferably of from 0.5 to 11 weight-%, more preferably of from 0.8 to 8 weight-%, more preferably of from 1.2 to 5 weight-%, more preferably of from 1.5 to 3 weight-%, and more preferably of from 1.8 to 2.5 weight-%.

It is preferred that the mixture prepared in (1) comprises seed crystals, wherein the seed crystals comprise one or more zeolitic materials having an AEI-type framework structure.

It is preferred that the mixture prepared in (1), comprises hydroxide salts.

It is preferred that the molar ratio OH⁻:Si in the mixture prepared in (1) is in the range of from 0.05 to 5, preferably of from 0.1 to 3, more preferably of from 0.2 to 1, more preferably of from 0.3 to 0.8, more preferably of from 0.45 to 0.65, more preferably of from 0.5 to 0.6, and more preferably of from 0.52 to 0.56.

It is preferred that the mixture prepared in (1) comprises one or more metals selected from the group consisting of alkali metals and alkaline earth metals, preferably one or more metals selected from the group consisting of Li, Na, K, Rb, Cs, Mg, and Ca, more preferably from the group consisting of Li, Na, and K, wherein more preferably the mixture prepared in (1) or comprises K and/or Na, preferably Na.

In case where the mixture prepared in (1) comprises one or more metals selected from the group consisting of alkali metals and alkaline earth metals, it is preferred that the mixture prepared in (1) comprises Mg, Ca, or Mg and Ca.

In case where the mixture prepared in (1) comprises one or more metals selected from the group consisting of alkali metals and alkaline earth metals, it is further preferred that the molar ratio of the one or more metals selected from the group consisting of alkali metals and alkaline earth metals to the one or more organotemplates in the mixture prepared in (1) is in the range of from 0.01 or less to 50, preferably of from 0.05 or less to 25, more preferably of from 0.1 or less to 15, more preferably of from 0.5 or less to 10, more preferably of from 1 to 7, more preferably of from 2 to 5, more preferably of from 3 to 4, and more preferably of from 3.4 to 3.6.

It is preferred that heating in (2) is conducted for a duration in the range of from 0.25 to 12 d, preferably of from 0.5 to 8 d, more preferably of from 1 to 6 d, more preferably of from 1.5 to 4.5 d, more preferably of from 2 to 4 d, and more preferably of from 2.5 to 3.5 d.

It is preferred that heating in (2) is conducted at a temperature in the range of from 80 to 220° C., preferably of from 100 to 200° C., more preferably of from 120 to 180° C., more preferably of from 130 to 170° C., more preferably of from 140 to 160° C., and more preferably of from 145 to 155° C.

It is preferred that heating in (2) is conducted under autogenous pressure, preferably under solvothermal conditions, more preferably under hydrothermal conditions, wherein preferably heating in (2) is performed in a pressure tight vessel, preferably in an autoclave.

It is preferred that the zeolitic material crystallized in (2) has an AEI-type framework structure.

It is preferred that the process for the preparation of a zeolitic material having an AEI-type framework structure comprising SiO₂, Al₂O₃ and B₂O₃ further comprises
(3) subjecting the zeolitic material obtained in (2) to ion exchange with one or more metal cations M.

In case where the process comprises (3), it is preferred that (3) comprises
(3a) subjecting the zeolitic material obtained in (2) to one or more ion exchange procedures with H⁺ and/or NH₄⁺, preferably with NH₄⁺;
(3b) subjecting the zeolitic material obtained in (3a) to one or more ion exchange procedures with the one or more metal cations M;
wherein independently from one another (3a) and/or (3b) is preferably repeated 1 to 3 times, more preferably once or twice, and more preferably once.

It is further preferred that in (3) the zeolitic material obtained in (2) is directly subject to ion exchange with the one or more metal cations M, wherein no ion-exchange step is performed prior to ion exchange of the zeolitic material obtained in (2) with the one or more metal cations M.

It is yet further preferred that in (3) the one or more metal cations M are selected from the group consisting of Sr, Zr, Cr, Mg, Mo, Fe, Co, Ni, Cu, Zn, Ru, Rh, Pd, Ag, Os, Ir, Pt, Au, La, Ce, Pr, Nd, Sm, Eu, Gd, Tb, Dy, Ho, Er, Tm, Yb, Lu, Y, Sc, and mixtures of two or more thereof, preferably selected from the group consisting of Sr, Zr, Cr, Mg, Mo, Fe, Co, Ni, Cu, Zn, Ru, Rh, Pd, Ag, Os, Ir, Pt, Au, and mixtures of two or more thereof, more preferably from the group consisting of Sr, Cr, Mo, Fe, Co, Ni, Cu, Zn, Ag, and mixtures of two or more thereof, more preferably from the group consisting of Cr, Mg, Mo, Fe, Ni, Cu, Zn, Ag, and mixtures of two or more thereof, more preferably from the group consisting of Mg, Mo, Fe, Ni, Cu, Zn, Ag, and mixtures of two or more thereof, wherein more preferably the one or more cations M comprise Cu and/or Fe, preferably Cu, wherein even more preferably the one or more cations M consist of Cu and/or Fe, preferably of Cu.

Yet further, it is preferred that in (3) the one or more metal cations M are provided as salts, preferably as one or more salts selected from the group consisting of halides, sulfate, nitrate, phosphate, acetate, and mixtures of two or more thereof, more preferably from the group consisting of sulfate, nitrate, acetate, and mixtures of two or more thereof, wherein more preferably the one or more metal cations M used for preparing the mixture according to (1) are provided as nitrates and/or acetates, and more preferably as acetates.

It is preferred that after (2) and prior to (3) the process comprises
(i) optionally isolating the zeolitic material obtained in (2), preferably by filtration; and/or, preferably and
(ii) optionally washing the zeolitic material obtained in (2) or (i), preferably with distilled water; and/or, preferably and
(iii) optionally drying the zeolitic material obtained in (2), (i), or (ii);
and/or, preferably and
(iv) optionally calcining the zeolitic material obtained in (2), (i), (ii), or (iii).

It is preferred that calcination in (iv) is conducted for a duration in the range of from 0.5 to 15 h, preferably of from 1 to 10 h, more preferably of from 1.5 to 8 h, more preferably of from 2 to 6 h, more preferably of from 2.5 to 5.5 h, more preferably of from 3 to 5 h, and more preferably of from 3.5 to 4.5 h.

Furthermore and independently thereof, it is preferred that calcination in (iv) is conducted at a temperature in the range of from 300 to 900° C., preferably of from 350 to 800° C., more preferably of from 400 to 750° C., more preferably of from 450 to 700° C., more preferably of from 500 to 650° C., and more preferably of from 560 to 600° C.

It is preferred that the one or more sources of SiO₂ are selected from the group consisting of silicon containing zeolites having a FAU, FER, GIS, MOR, LTA, TON, MTT, BEA and/or MFI framework structure, silicas, silicates, silicic acid and combinations of two or more thereof, preferably selected from the group consisting of silicon containing zeolites having a FAU, GIS, BEA and/or MFI framework structure, silicas, alkali metal silicates, silicic acid, and combinations of two or more thereof, more preferably selected from the group consisting of a silicon containing zeolite having a FAU, BEA and/or MFI framework structure, fumed silica, colloidal silica, reactive amorphous solid silica, silica gel, pyrogenic silica, lithium silicates, sodium silicates, potassium silicates, silicic acid, and combinations of two or more thereof, more preferably selected from the group consisting of a silicon containing zeolite having a FAU framework structure, colloidal silica, fumed silica, silica gel, pyrogenic silica, and combinations of two or more thereof, wherein more preferably the one or more sources of SiO₂ comprises a silicon containing zeolite having a FAU framework structure, colloidal silica and/or fumed silica.

In this regard, it is preferred that the zeolite having an FAU-type framework structure is selected from the group consisting of ZSM-3, Faujasite, [Al—Ge—O]-FAU, CSZ-1, ECR-30, Zeolite X, Zeolite Y, LZ-210, SAPO-37, ZSM-20, Na—X, US-Y, Na—Y, [Ga—Ge—O]-FAU, Li-LSX, [Ga—Al—Si—O]-FAU, and [Ga—Si—O]-FAU, including mixtures of two or more thereof,
preferably from the group consisting of ZSM-3, Faujasite, CSZ-1, ECR-30, Zeolite X, Zeolite Y, LZ-210, ZSM-20, Na—X, US-Y, Na—Y, and Li-LSX, including mixtures of two or more thereof,
more preferably from the group consisting of Faujasite, Zeolite X, Zeolite Y, Na—X, US-Y, and Na—Y, including mixtures of two or more thereof, more preferably from the group consisting of Faujasite, Zeolite X, and Zeolite Y, including mixtures of two or more thereof,
wherein more preferably the zeolite having an FAU-type framework structure comprises zeolite X and/or zeolite Y, preferably zeolite Y, wherein more preferably the zeolite having an FAU-type framework structure is zeolite X and/or zeolite Y, preferably zeolite Y.

Furthermore and independently thereof, it is preferred that the zeolite having a BEA-type framework structure is selected from the group consisting of zeolite beta, Tschernichite, [B—Si—O]—*BEA, CIT-6, [Ga—Si—O]—*BEA, Beta polymorph B, SSZ-26, SSZ-33, Beta polymorph A, [Ti—Si—O]—*BEA, and pure silica beta, including mixtures of two or more thereof,
preferably from the group consisting of zeolite beta, CIT-6, Beta polymorph B, SSZ-26, SSZ-33, Beta polymorph A, and pure silica beta, including mixtures of two or more thereof,
wherein more preferably the zeolite having a BEA-type framework structure comprises zeolite beta, preferably zeolite beta obtained from organotemplate-free synthesis,
wherein more preferably the zeolite having a BEA-type framework structure is zeolite beta, preferably zeolite beta obtained from organotemplate mediated synthesis or obtained from organotemplate-free synthesis, and more preferably zeolite beta obtained from organotemplate-free synthesis.

Furthermore and independently thereof, it is preferred that the zeolite having an MFI-type framework structure is selected from the group consisting of Silicalite, ZSM-5, [Fe—Si—O]-MFI, [Ga—Si—O]-MFI, [As—Si—O]-MFI, AMS-1B, AZ-1, Bor-C, Encilite, Boralite C, FZ-1, LZ-105, Mutinaite, NU-4, NU-5, TS-1, TSZ, TSZ-Ill, TZ-01, USC-4, USI-108, ZBH, ZKQ-1B, ZMQ-TB, MnS1, and FeS-1, including mixtures of two or more thereof,
preferably from the group consisting of Silicalite, ZSM-5, AMS-1B, AZ-1, Encilite, FZ-1, LZ-105, Mutinaite, NU-4, NU-5, TS-1, TSZ, TSZ-Ill, TZ-01, USC-4, USI-108, ZBH, ZKQ-1B, and ZMQ-TB, including mixtures of two or more thereof,
wherein more preferably the zeolite having an MFI-type framework structure comprises Silicalite and/or ZSM-5, preferably ZSM-5,
wherein more preferably the zeolite having an MFI-type framework structure is zeolite Silicalite and/or ZSM-5, preferably ZSM-5.

It is preferred that the one or more sources for B₂O₃ is selected from the group consisting of boric acid, borates, boric esters, and mixtures of two or more thereof, preferably from the group consisting of boric acid, borates, triethyl borate, trimethyl borateboric esters, and mixtures of two or more thereof, wherein more preferably the one or more sources for B₂O₃ comprises boric acid and/or borates, preferably boric acid, wherein more preferably the one or more sources for B₂O₃ consists of boric acid and/or borates, preferably of boric acid.

It is preferred that the one or more sources of Al₂O₃ comprises one or more compounds selected from the group consisting of aluminum containing zeolites having a FAU framework structure and aluminum salts, wherein preferably the one or more sources of Al₂O₃ comprises an aluminum containing zeolite having a FAU framework structure or aluminum nitrate, wherein more preferably the one or more sources of Al₂O₃ consists of an aluminum containing zeolite having a FAU framework structure or aluminum nitrate.

It is preferred that the one or more sources of SiO₂ and the one or more sources of Al₂O₃ comprise silicon and aluminum containing zeolites having a FAU framework structure, wherein preferably the one or more sources of SiO₂ and the one or more sources of Al₂O₃ consist of a silicon and aluminum containing zeolite having a FAU framework structure.

It is preferred that the solvent system is selected from the group consisting of optionally branched (C1-C4)alcohols, distilled water, and mixtures thereof, preferably from the group consisting of optionally branched (C1-C3)alcohols, distilled water, and mixtures thereof, more preferably from the group consisting of methanol, ethanol, distilled water, and mixtures thereof, wherein more preferably the solvent system comprises distilled water, wherein more preferably the solvent system consists of distilled water.

It is preferred that the mixture prepared in (1) and crystallized in (2) contains 5 wt.-% or less of phosphorous (P) calculated as the element and based on 100 wt.-% of the mixture prepared in (1), preferably 3 wt.-% or less, more preferably 1 wt.-% or less, more preferably 0.5 wt.-% or less, more preferably 0.1 wt.-% or less, more preferably 0.05 wt.-% or less, more preferably 0.01 wt.-% or less, more preferably 0.005 wt.-% or less, more preferably 0.001 wt.-% or less, more preferably 0.0005 wt.-% or less, and more preferably 0.0001 wt.-% or less.

It is preferred that the mixture prepared in (1) comprises seed crystals, wherein the seed crystals comprise one or more zeolitic materials having the framework structure of the zeolitic material comprising SiO₂, B₂O₃ and Al₂O₃ in its framework structure obtained according to the process of any one of embodiments 15 to 59, wherein preferably the one or more zeolitic materials of the seed crystals is obtainable and/or obtained according to the process of any one of embodiments 15 to 59.

The present invention also relates to a zeolitic material having an AEI-type framework structure, preferably according to any one of the particular and preferred embodiments of the present invention, wherein the zeolitic material is obtainable and/or obtained according to the process of any one of the particular and preferred embodiments of the present invention.

The present invention also relates to a process for the treatment of NOₓ by selective catalytic reduction comprising
(A) providing a gas stream containing one or more nitrogen oxides;
(B) contacting the gas stream provided in step (A) with a zeolitic material according to any one of the particular and preferred embodiments of the present invention.

It is preferred that the gas stream provided in (A) further comprises one or more reducing agents, wherein the reducing agent preferably comprises ammonia and/or urea.

It is preferred that the gas stream provided in (A) comprises one or more waste gases, preferably one or more waste gases from one or more industrial processes, wherein more preferably the waste gas stream comprises one or more waste gas streams obtained in processes for producing adipic acid, nitric acid, hydroxylamine derivatives, caprolactame, glyoxal, methyl-glyoxal, glyoxylic acid or in processes for burning nitrogeneous materials, including mixtures of waste gas streams from two or more of said processes, wherein even more preferably the waste gas stream comprises one or more waste gas streams obtained in processes for producing adipic acid and/or nitric acid.

It is preferred that the gas stream provided in (A) comprises one or more waste gases from an internal combustion engine, preferably from a diesel engine or from a lean burn gasoline engine.

It is preferred that the contacting of the gas stream with the zeolitic material in (B) is conducted at a temperature comprised in the range of from 250 to 550° C., preferably of from 300 to 500° C., more preferably of from 325 to 450° C., more preferably of from 350 to 425° C., more preferably of from 380 to 420° C., and even more preferably of from 390 to 410° C.

The present invention also relates to an apparatus for the treatment of a gas stream containing NOₓ, the apparatus comprising a catalyst bed provided in fluid contact with the gas stream to be treated, wherein the catalyst bed comprises a zeolitic material according to any one of the particular and preferred embodiments of the present invention.

In this regard, it is preferred that the catalyst bed is a fixed bed catalyst or a fluidized bed catalyst, preferably a fixed bed catalyst.

Furthermore, it is preferred that the apparatus further comprises one or more devices provided upstream of the catalyst bed for injecting one or more reducing agents into the gas stream, wherein the reducing agent preferably comprises ammonia and/or urea.

The present invention also relates to a use of a zeolitic material according to any one of the particular and preferred embodiments of the present invention as a molecular sieve, as an adsorbent, for ion-exchange, as a catalyst or a precursor thereof, and/or as a catalyst support or a precursor thereof, preferably as a catalyst or a precursor thereof and/or as a catalyst support or a precursor thereof, more preferably as a catalyst or a precursor thereof, more preferably as a catalyst for the selective catalytic reduction (SCR) of nitrogen oxides NOₓ; for the storage and/or adsorption of CO₂; for the oxidation of NH₃, in particular for the oxidation of NH₃ slip in diesel systems; for the decomposition of N₂O; as an additive in fluid catalytic cracking (FCC) processes; and/or as a catalyst in organic conversion reactions, preferably in the conversion of alcohols to olefins, and more preferably in methanol to olefin (MTO) catalysis; more preferably for the selective catalytic reduction (SCR) of nitrogen oxides NOₓ, and more preferably for the selective catalytic reduction (SCR) of nitrogen oxides NOₓ in exhaust gas from a combustion engine, preferably from a diesel engine or from a lean burn gasoline engine.

The present invention is further illustrated by the following set of embodiments and combinations of embodiments resulting from the dependencies and back-references as indicated. In particular, it is noted that in each instance where a range of embodiments is mentioned, for example in the context of a term such as “The process of any one of embodiments 1 to 4”, every embodiment in this range is meant to be explicitly disclosed for the skilled person, i.e. the wording of this term is to be understood by the skilled person as being synonymous to “The process of any one of embodiments 1, 2, 3, and 4”. Further, it is explicitly noted that the following set of embodiments is not the set of claims determining the extent of protection, but represents a suitably structured part of the description directed to general and preferred aspects of the present invention.
1. A zeolitic material having an AEI-type framework structure comprising SiO₂, Al₂O₃ and B₂O₃, wherein the Al:B molar ratio of the zeolitic material, preferably of the framework structure of the zeolitic material, is comprised in the range of from 3 to 500, and wherein the zeolitic material displays an Si:(Al+B) molar ratio of the zeolitic material, preferably of the framework structure of the zeolitic material, which is comprised in the range of from 2 to 11.
2. The zeolitic material of embodiment 1, wherein the Al:B molar ratio of the zeolitic material, preferably of the framework structure of the zeolitic material, is in the range of from 5 to 200, preferably of from 8 to 100, more preferably of from 10 to 50, more preferably of from 11 to 35, more preferably of from 12 to 25, more preferably of from 13 to 20, and more preferably of from 15 to 16.
3. The zeolitic material of embodiment 1 or 2, wherein the Si:B molar ratio of the zeolitic material, preferably of the framework structure of the zeolitic material, is 30 or more, and is preferably in the range of from 40 to 2,000, preferably of from 50 to 1,200, more preferably of from 60 to 800, more preferably of from 70 to 500, more preferably of from 100 to 300, more preferably of from 150 to 250, and more preferably of from 180 to 220.
4. The zeolitic material of any one of embodiments 1 to 3, wherein the Si:Al molar ratio of the zeolitic material, preferably of the framework structure of the zeolitic material, is in the range of from 2 to 500, preferably of from 3 to 200, more preferably of from 4 to 100, more preferably of from 5 to 50, more preferably of from 6 to 25, more preferably of from 7 to 20, more preferably of from 8 to 15, more preferably of from 9 to 12, and more preferably of from 10 to 11.
5. The zeolitic material of any one of embodiments 1 to 4, wherein the Si:(Al+B) molar ratio of the zeolitic material, preferably of the framework structure of the zeolitic material, is in the range of from 4 to 10.5, preferably of from 5 to 10, more preferably of from 5.5 to 9.5, more preferably of from 6 to 9, more preferably of from 6.5 to 8.5, and more preferably of from 7 to 8.
6. The zeolitic material of any one of embodiments 1 to 5, wherein the mean particle size of the primary crystals of the zeolitic material is in the range of from 0.5 to 4.0 μm, preferably of from 0.6 to 3.0 μm, more preferably of from 0.8 to 2.5 μm, more preferably of from 1.0 to 2.0 μm, more preferably of from 1.2 to 1.8 μm, and more preferably of from 1.4 to 1.6 μm, wherein the mean particle size of the primary crystals of the zeolitic material is preferably obtained according to the method of Reference Example 4.
7. The zeolitic material of any one of embodiments 1 to 6, wherein the primary crystals of the zeolitic material display a mean aspect ratio of greater than 1.2, and preferably a mean aspect ratio in the range of from 1.3 to 6.0, more preferably from 1.4 to 5.0, more preferably from 1.5 to 4.5, more preferably from 2.0 to 4.0, and more preferably from 2.5 to 3.5, wherein the mean aspect ratio of the primary crystals of the zeolitic material is preferably obtained according to the method of Reference Example 4.
8. The zeolitic material of any one of embodiments 1 to 7, wherein 95 or more weight-% of the framework of the zeolitic material consists of Si, Al, B, O, and H, calculated based on the total weight of the framework of the zeolitic material, preferably 95 to 100 weight-%, more preferably 97 to 100 weight-%, more preferably 99 to 100 weight-%.
9. The zeolitic material of any one of embodiments 1 to 8, wherein the zeolitic material further contains one or more metals selected from the group consisting of alkali metals and alkaline earth metals at the ion-exchange sites of the framework structure, preferably one or more metals selected from the group consisting of Li, Na, K, Rb, Cs, Mg, and Ca, more preferably from the group consisting of Li, Na, and K, wherein more preferably the zeolitic material further contains K and/or Na, preferably Na, at the ion-exchange sites of the framework structure.
10. The zeolitic material of embodiment 9, wherein the zeolitic material further contains Mg, Ca, or Mg and Ca at the ion-exchange sites of the framework structure.
11. The zeolitic material of any one of embodiments 1 to 10, wherein the zeolitic material comprises one or more metal cations M selected from the group consisting of Sr, Zr, Cr, Mo, Fe, Co, Ni, Cu, Zn, Ru, Rh, Pd, Ag, Os, Ir, Pt, Au, La, Ce, Pr, Nd, Sm, Eu, Gd, Tb, Dy, Ho, Er, Tm, Yb, Lu, Y, Sc, and mixtures of two or more thereof, preferably selected from the group consisting of Sr, Zr, Cr, Mo, Fe, Co, Ni, Cu, Zn, Ru, Rh, Pd, Ag, Os, Ir, Pt, Au, and mixtures of two or more thereof, more preferably from the group consisting of Sr, Cr, Mo, Fe, Co, Ni, Cu, Zn, Ag, and mixtures of two or more thereof, more preferably from the group consisting of Cr, Mo, Fe, Ni, Cu, Zn, Ag, and mixtures of two or more thereof, more preferably from the group consisting of Mo, Fe, Ni, Cu, Zn, Ag, and mixtures of two or more thereof, wherein more preferably the one or more cations M comprise Cu and/or Fe, preferably Cu, wherein even more preferably the one or more cations M consist of Cu and/or Fe, preferably of Cu, wherein the one or more metal cations M are preferably located at the ion-exchange sites of the framework structure of the zeolitic material.
12. The zeolitic material of embodiment 11, wherein the zeolitic material comprises the one or more metal cations M in an amount in the range of from 0.01 to 5 weight-% based on 100 weight-% of Si in the zeolitic material calculated as SiO₂, preferably in the range of from 0.05 to 4 weight-%, more preferably in the range of from 0.1 to 3 weight-%, more preferably in the range of from 0.2 to 2.5 weight-%, more preferably in the range of from 0.4 to 2 weight-%, more preferably in the range of from 0.6 to 1.5 weight-%, and more preferably in the range of from 0.8 to 1.2 weight-%.
13. The zeolitic material of embodiment 11 or 12, wherein 95 or more weight-% of the zeolitic material consists of Si, Al, B, O, H, and the one or more metal cations M, calculated based on the total weight of the zeolitic material, preferably 95 to 100 weight-%, more preferably 97 to 100 weight-%, more preferably 99 to 100 weight-%.
14. The zeolitic material of any one of embodiments 1 to 13, wherein the zeolitic material having an AEI-type framework structure is selected from the group consisting of SSZ-39, SAPO-18, and SIZ-8, including mixtures of two or more thereof, wherein preferably the zeolitic material comprises SSZ-39, and wherein more preferably the zeolitic material is SSZ-39.
15. The zeolitic material of any one of embodiments 1 to 14, wherein the zeolitic material contains 5 wt.-% or less of phosphorous (P) calculated as the element and based on 100 wt.-% of SiO₂ contained in the zeolitic material, preferably 3 wt.-% or less, more preferably 1 wt.-% or less, more preferably 0.5 wt.-% or less, more preferably 0.1 wt.-% or less, more preferably 0.05 wt.-% or less, more preferably 0.01 wt.-% or less, more preferably 0.005 wt.-% or less, more preferably 0.001 wt.-% or less, more preferably 0.0005 wt.-% or less, and more preferably 0.0001 wt.-% or less.
16. A process for the preparation of a zeolitic material having an AEI-type framework structure comprising SiO₂, Al₂O₃ and B₂O₃, preferably of a zeolitic material according to any one of embodiments 1 to 15, the process comprising
(1) preparing a mixture comprising one or more organotemplates as structure directing agents, one or more sources of SiO₂, one or more sources of B₂O₃, one or more sources of Al₂O₃, optionally seed crystals, and a solvent system;
(2) heating the mixture obtained in (1) for crystallizing a zeolitic material comprising SiO₂, B₂O₃ and Al₂O₃ in its framework structure from the mixture;
wherein the one or more organotemplates comprises one or more tetraalkylammonium cation R¹R²R³R⁴N⁺-containing compounds, wherein R¹, R², R³ independently from one another stand for alkyl, and wherein R⁴ stands for alkyl or aryl.
17. The process of embodiment 16, wherein the molar ratio of Si:B of the silicon to the boron, calculated as the element, respectively, in the mixture prepared according to (1) is in the range of from 1 to 80, preferably of from 2 to 50, more preferably of from 3 to 35, more preferably of from 4 to 25, more preferably of from 6 to 20, more preferably of from 8 to 18, and more preferably of from 10 to 15.
18. The process of embodiment 16 or 17, wherein the molar ratio of Si:Al of the silicon to the aluminum, calculated as the element, respectively, in the mixture prepared according to (1) is in the range of from 1 to 300, preferably of from 3 to 200, more preferably of from 5 to 120, more preferably of from 10 to 80, more preferably of from 15 to 50, more preferably of from 20 to 35, and more preferably of from 25 to 30.
19. The process of any one of embodiments 16 to 18, wherein the molar ratio SiO₂:organotemplate of the one or more sources for SiO₂ to the one or more organotemplates in the mixture prepared in (1) is in the range of from 1 to 50, preferably of from 2 to 35, more preferably of from 3 to 25, more preferably of from 4 to 18, more preferably of from 5 to 12, more preferably of from 6 to 9, and more preferably of from 6.5 to 7.
20. The process of any one of embodiments 16 to 19, wherein R¹, R², R³ and R⁴ independently from one another stand for alkyl, and wherein R³ and R⁴ form a common alkyl chain.
21. The process of embodiment 20, wherein R¹ and R² independently from one another stand for optionally branched (C₁-C₆)alkyl, preferably (C₁-C₅)alkyl, more preferably (C₁-C₄)alkyl, more preferably (C₁-C₃)alkyl, wherein more preferably R¹ and R² independently from one another stand for methyl or ethyl, and more preferably for methyl.
22. The process of embodiment 20 or 21, wherein R³ and R⁴ form a common (C₄-C₈)alkyl chain, more preferably a common (C₄-C₇)alkyl chain, more preferably a common (C₄-C₆)alkyl chain, wherein more preferably said common alkyl chain is a C₄ or C₅ alkyl chain, and more preferably a C₅ alkyl chain.
23. The process of any one of embodiments 20 to 22, wherein the one or more tetraalkylammonium cation R¹R²R³R⁴N⁺-containing compounds comprise one or more ammonium compounds selected from the group consisting of N,N-di(C₁-C₄)alkyl-3,5-di(C₁-C₄)alkylpyrrolidinium compounds, N,N-di(C₁-C₄)alkyl-3,5-di(C₁-C₄)alkylpiperidinium compounds, N,N-di(C₁-C₄)alkyl-3,5-di(C₁-C₄)alkylhexahydroazepinium compounds, N,N-di(C₁-C₄)alkyl-2,6-di(C₁-C₄)alkylpyrrolidinium compounds, N,N-di(C₁-C₄)alkyl-2,6-di(C₁-C₄)alkylpiperidinium compounds, N,N-di(C₁-C₄)alkyl-2,6-di(C₁-C₄)alkylhexahydroazepinium compounds, and mixtures of two or more thereof, preferably from the group consisting of N,N-di(C₁-C₃)alkyl-3,5-di(C₁-C₃)alkylpyrrolidinium compounds, N,N-di(C₁-C₃)alkyl-3,5-di(C₁-C₃)alkylpiperidinium compounds, N,N-di(C₁-C₃)alkyl-3,5-di(C₁-C₃)alkylhexahydroazepinium compounds, N,N-di(C₁-C₃)alkyl-2,6-di(C₁-C₃)alkylpyrrolidinium compounds, N,N-di(C₁-C₃)alkyl-2,6-di(C₁-C₃)alkylpiperidinium compounds, N,N-di(C₁-C₃)alkyl-2,6-di(C₁-C₃)alkylhexahydroazepinium compounds, and mixtures of two or more thereof,
   more preferably from the group consisting of N,N-di(C₁-C₂)alkyl-3,5-di(C₁-C₂)alkylpyrrolidinium compounds, N,N-di(C₁-C₂)alkyl-3,5-di(C₁-C₂)alkylpiperidinium compounds, N,N-di(C₁-C₂)alkyl-3,5-di(C₁-C₂)alkylhexahydroazepinium compounds, N,N-di(C₁-C₂)alkyl-2,6-di(C₁-C₂)alkylpyrrolidinium compounds, N,N-di(C₁-C₂)alkyl-2,6-di(C₁-C₂)alkylpiperidinium compounds, N,N-di(C₁-C₂)alkyl-2,6-di(C₁-C₂)alkylhexahydroazepinium compounds, and mixtures of two or more thereof,
   more preferably from the group consisting of N,N-di(C₁-C₂)alkyl-3,5-di(C₁-C₂)alkylpiperidinium compounds, N,N-di(C₁-C₂)alkyl-2,6-di(C₁-C₂)alkylpiperidinium compounds, and mixtures of two or more thereof, wherein more preferably the one or more tetraalkylammonium cation R¹R²R³R⁴N⁺-containing compounds comprise one or more N,N-dimethyl-3,5-dimethylpiperidinium and/or N,N-diethyl-2,6-dimethylpiperidinium compounds, preferably one or more N,N-dimethyl-3,5-dimethylpiperidinium compounds.
24. The process of embodiment 23, wherein the N,N-dialkyl-2,6-dialkylpyrrolidinium compounds, N,N-dialkyl-2,6-dialkylpiperidinium compounds, and/or N,N-dialkyl-2,6-dialkylhexahydroazepinium compounds display the cis configuration, the trans configuration, or contain a mixture of the cis and trans isomers,
   wherein preferably the N,N-dialkyl-2,6-dialkylpyrrolidinium compounds, N,N-dialkyl-2,6-dialkylpiperidinium compounds, and/or N,N-dialkyl-2,6-dialkylhexahydroazepinium compounds display the cis configuration,
   wherein more preferably the one or more tetraalkylammonium cation R¹R²R³R⁴N⁺-containing compounds comprise one or more ammonium compounds selected from the group consisting of N,N-di(C₁-C₂)alkyl-cis-2,6-di(C₁-C₂)alkylpiperidinium compounds, and mixtures of two or more thereof, wherein more preferably the one or more tetraalkylammonium cation R¹R²R³R⁴N⁺-containing compounds comprise one or more N,N-diethyl-cis-2,6-dimethylpiperidinium compounds.
25. The process of any one of embodiments 16 to 24, wherein the one or more organotemplates are provided as salts, preferably as one or more salts selected from the group consisting of halides, sulfate, nitrate, phosphate, acetate, and mixtures of two or more thereof, more preferably from the group consisting of bromide, chloride, hydroxide, sulfate, and mixtures of two or more thereof, wherein more preferably the one or more organotemplates are provided as hydroxides and/or bromides, and more preferably as hydroxides.
26. The process of any one of embodiments 16 to 25, wherein the mixture prepared in (1) comprises seed crystals, wherein the amount of seed crystals comprised in the mixture prepared in (1) is in the range of from 0.1 to 15 weight-% based on 100 weight-% of Si in the mixture calculated as SiO₂, and preferably of from 0.5 to 11 weight-%, more preferably of from 0.8 to 8 weight-%, more preferably of from 1.2 to 5 weight-%, more preferably of from 1.5 to 3 weight-%, and more preferably of from 1.8 to 2.5 weight-%.
27. The process of any one of embodiments 16 to 26, wherein the mixture prepared in (1) comprises seed crystals, wherein the seed crystals comprise one or more zeolitic materials having an AEI-type framework structure.
28. The process of any one of embodiments 16 to 27, wherein the mixture prepared in (1), comprises hydroxide salts.
29. The process of any one of embodiments 16 to 28, wherein the molar ratio OH⁻:Si in the mixture prepared in (1) is in the range of from 0.05 to 5, preferably of from 0.1 to 3, more preferably of from 0.2 to 1, more preferably of from 0.3 to 0.8, more preferably of from 0.45 to 0.65, more preferably of from 0.5 to 0.6, and more preferably of from 0.52 to 0.56.
30. The process of any one of embodiments 16 to 29, wherein the mixture prepared in (1) comprises one or more metals selected from the group consisting of alkali metals and alkaline earth metals, preferably one or more metals selected from the group consisting of Li, Na, K, Rb, Cs, Mg, and Ca, more preferably from the group consisting of Li, Na, and K, wherein more preferably the mixture prepared in (1) or comprises K and/or Na, preferably Na.
31. The process of any one of embodiments 30, wherein the mixture prepared in (1) comprises Mg, Ca, or Mg and Ca.
32. The process of embodiment 30 or 31, wherein the molar ratio of the one or more metals selected from the group consisting of alkali metals and alkaline earth metals to the one or more organotemplates in the mixture prepared in (1) is in the range of from 0.01 or less to 50, preferably of from 0.05 or less to 25, more preferably of from 0.1 or less to 15, more preferably of from 0.5 or less to 10, more preferably of from 1 to 7, more preferably of from 2 to 5, more preferably of from 3 to 4, and more preferably of from 3.4 to 3.6.
33. The process of any one of embodiments 16 to 32, wherein heating in (2) is conducted for a duration in the range of from 0.25 to 12 d, preferably of from 0.5 to 8 d, more preferably of from 1 to 6 d, more preferably of from 1.5 to 4.5 d, more preferably of from 2 to 4 d, and more preferably of from 2.5 to 3.5 d.
34. The process of any one of embodiments 16 to 33, wherein heating in (2) is conducted at a temperature in the range of from 80 to 220° C., preferably of from 100 to 200° C., more preferably of from 120 to 180° C., more preferably of from 130 to 170° C., more preferably of from 140 to 160° C., and more preferably of from 145 to 155° C.
35. The process of any one of embodiments 16 to 34, wherein heating in (2) is conducted under autogenous pressure, preferably under solvothermal conditions, more preferably under hydrothermal conditions, wherein preferably heating in (2) is performed in a pressure tight vessel, preferably in an autoclave.
36. The process of any one of embodiments 16 to 35, wherein the zeolitic material crystallized in (2) has an AEI-type framework structure.
37. The process of any one of embodiments 16 to 36, further comprising
   (3) subjecting the zeolitic material obtained in (2) to ion exchange with one or more metal cations M.
38. The process of embodiment 37, wherein (3) comprises
   (3a) subjecting the zeolitic material obtained in (2) to one or more ion exchange procedures with H⁺ and/or NH₄⁺, preferably with NH₄⁺;
   (3b) subjecting the zeolitic material obtained in (3a) to one or more ion exchange procedures with the one or more metal cations M;
   wherein independently from one another (3a) and/or (3b) is preferably repeated 1 to 3 times, more preferably once or twice, and more preferably once.
39. The process of embodiment 37 or 38, wherein in (3) the zeolitic material obtained in (2) is directly subject to ion exchange with the one or more metal cations M, wherein no ion-exchange step is performed prior to ion exchange of the zeolitic material obtained in (2) with the one or more metal cations M.
40. The process of any of embodiments 37 to 39, wherein the one or more metal cations M are selected from the group consisting of Sr, Zr, Cr, Mg, Mo, Fe, Co, Ni, Cu, Zn, Ru, Rh, Pd, Ag, Os, Ir, Pt, Au, La, Ce, Pr, Nd, Sm, Eu, Gd, Tb, Dy, Ho, Er, Tm, Yb, Lu, Y, Sc, and mixtures of two or more thereof, preferably selected from the group consisting of Sr, Zr, Cr, Mg, Mo, Fe, Co, Ni, Cu, Zn, Ru, Rh, Pd, Ag, Os, Ir, Pt, Au, and mixtures of two or more thereof, more preferably from the group consisting of Sr, Cr, Mo, Fe, Co, Ni, Cu, Zn, Ag, and mixtures of two or more thereof, more preferably from the group consisting of Cr, Mg, Mo, Fe, Ni, Cu, Zn, Ag, and mixtures of two or more thereof, more preferably from the group consisting of Mg, Mo, Fe, Ni, Cu, Zn, Ag, and mixtures of two or more thereof, wherein more preferably the one or more cations M comprise Cu and/or Fe, preferably Cu, wherein even more preferably the one or more cations M consist of Cu and/or Fe, preferably of Cu.
41. The process of any of embodiments 37 or 40, wherein the one or more metal cations M are provided as salts, preferably as one or more salts selected from the group consisting of halides, sulfate, nitrate, phosphate, acetate, and mixtures of two or more thereof, more preferably from the group consisting of sulfate, nitrate, acetate, and mixtures of two or more thereof, wherein more preferably the one or more metal cations M used for preparing the mixture according to (1) are provided as nitrates and/or acetates, and more preferably as acetates.
42. The process of any one of embodiments 37 to 41, wherein after (2) and prior to (3) the process comprises
   (i) optionally isolating the zeolitic material obtained in (2), preferably by filtration; and/or, preferably and
   (ii) optionally washing the zeolitic material obtained in (2) or (i), preferably with distilled water;
   and/or, preferably and
   (iii) optionally drying the zeolitic material obtained in (2), (i), or (ii);
   and/or, preferably and
   (iv) optionally calcining the zeolitic material obtained in (2), (i), (ii), or (iii).
43. The process of embodiment 42, wherein calcination in (iv) is conducted for a duration in the range of from 0.5 to 15 h, preferably of from 1 to 10 h, more preferably of from 1.5 to 8 h, more preferably of from 2 to 6 h, more preferably of from 2.5 to 5.5 h, more preferably of from 3 to 5 h, and more preferably of from 3.5 to 4.5 h.
44. The process of embodiment 42 or 43, wherein calcination in (iv) is conducted at a temperature in the range of from 300 to 900° C., preferably of from 350 to 800° C., more preferably of from 400 to 750° C., more preferably of from 450 to 700° C., more preferably of from 500 to 650° C., and more preferably of from 560 to 600° C.
45. The process of any one of embodiments 16 to 44, wherein the one or more sources of SiO₂ are selected from the group consisting of silicon containing zeolites having a FAU, FER, GIS, MOR, LTA, TON, MTT, BEA and/or MFI framework structure, silicas, silicates, silicic acid and combinations of two or more thereof, preferably selected from the group consisting of silicon containing zeolites having a FAU, GIS, BEA and/or MFI framework structure, silicas, alkali metal silicates, silicic acid, and combinations of two or more thereof, more preferably selected from the group consisting of a silicon containing zeolite having a FAU, BEA and/or MFI framework structure, fumed silica, colloidal silica, reactive amorphous solid silica, silica gel, pyrogenic silica, lithium silicates, sodium silicates, potassium silicates, silicic acid, and combinations of two or more thereof, more preferably selected from the group consisting of a silicon containing zeolite having a FAU framework structure, colloidal silica, fumed silica, silica gel, pyrogenic silica, and combinations of two or more thereof, wherein more preferably the one or more sources of SiO₂ comprises a silicon containing zeolite having a FAU framework structure, colloidal silica and/or fumed silica.
46. The process of embodiment 45, wherein the zeolite having an FAU-type framework structure is selected from the group consisting of ZSM-3, Faujasite, [Al—Ge—O]-FAU, CSZ-1, ECR-30, Zeolite X, Zeolite Y, LZ-210, SAPO-37, ZSM-20, Na—X, US-Y, Na—Y, [Ga—Ge—O]-FAU, Li-LSX, [Ga—Al—Si—O]-FAU, and [Ga—Si—O]-FAU, including mixtures of two or more thereof,
   preferably from the group consisting of ZSM-3, Faujasite, CSZ-1, ECR-30, Zeolite X, Zeolite Y, LZ-210, ZSM-20, Na—X, US-Y, Na—Y, and Li-LSX, including mixtures of two or more thereof,
   more preferably from the group consisting of Faujasite, Zeolite X, Zeolite Y, Na—X, US-Y, and Na—Y, including mixtures of two or more thereof, more preferably from the group consisting of Faujasite, Zeolite X, and Zeolite Y, including mixtures of two or more thereof,
   wherein more preferably the zeolite having an FAU-type framework structure comprises zeolite X and/or zeolite Y, preferably zeolite Y, wherein more preferably the zeolite having an FAU-type framework structure is zeolite X and/or zeolite Y, preferably zeolite Y.
47. The process of embodiment 45 or 46, wherein the zeolite having a BEA-type framework structure is selected from the group consisting of zeolite beta, Tschernichite, [B—Si—O]—*BEA, CIT-6, [Ga—Si—O]—*BEA, Beta polymorph B, SSZ-26, SSZ-33, Beta polymorph A, [Ti—Si—O]—*BEA, and pure silica beta, including mixtures of two or more thereof,
   preferably from the group consisting of zeolite beta, CIT-6, Beta polymorph B, SSZ-26, SSZ-33, Beta polymorph A, and pure silica beta, including mixtures of two or more thereof,
   wherein more preferably the zeolite having a BEA-type framework structure comprises zeolite beta, preferably zeolite beta obtained from organotemplate-free synthesis,
   wherein more preferably the zeolite having a BEA-type framework structure is zeolite beta, preferably zeolite beta obtained from organotemplate mediated synthesis or obtained from organotemplate-free synthesis, and more preferably zeolite beta obtained from organotemplate-free synthesis.
48. The process of any one of embodiments 45 to 47, wherein the zeolite having an MFI-type framework structure is selected from the group consisting of Silicalite, ZSM-5, [Fe—Si—O]-MFI, [Ga—Si—O]-MFI, [As—Si—O]-MFI, AMS-1B, AZ-1, Bor-C, Encilite, Boralite C, FZ-1, LZ105, Mutinaite, NU-4, NU-5, TS-1, TSZ, TSZ-Ill, TZ-01, USC-4, USI-108, ZBH, ZKQ-1B, ZMQ-TB, MnS-1, and FeS-1, including mixtures of two or more thereof,
   preferably from the group consisting of Silicalite, ZSM-5, AMS-1B, AZ-1, Encilite, FZ-1, LZ-105, Mutinaite, NU-4, NU-5, TS-1, TSZ, TSZ-Ill, TZ-01, USC-4, USI-108, ZBH, ZKQ1B, and ZMQ-TB, including mixtures of two or more thereof,
   wherein more preferably the zeolite having an MFI-type framework structure comprises Silicalite and/or ZSM-5, preferably ZSM-5,
   wherein more preferably the zeolite having an MFI-type framework structure is zeolite Silicalite and/or ZSM-5, preferably ZSM-5.
49. The process of any one of embodiments 16 to 48, wherein the one or more sources for B₂O₃ is selected from the group consisting of boric acid, borates, boric esters, and mixtures of two or more thereof, preferably from the group consisting of boric acid, borates, triethyl borate, trimethyl borateboric esters, and mixtures of two or more thereof, wherein more preferably the one or more sources for B₂O₃ comprises boric acid and/or borates, preferably boric acid, wherein more preferably the one or more sources for B₂O₃ consists of boric acid and/or borates, preferably of boric acid.
50. The process of any one of embodiments 16 to 49, wherein the one or more sources of Al₂O₃ comprises one or more compounds selected from the group consisting of aluminum containing zeolites having a FAU framework structure and aluminum salts, wherein preferably the one or more sources of Al₂O₃ comprises an aluminum containing zeolite having a FAU framework structure or aluminum nitrate, wherein more preferably the one or more sources of Al₂O₃ consists of an aluminum containing zeolite having a FAU framework structure or aluminum nitrate.
51. The process of any one of embodiments 16 to 50, wherein the one or more sources of SiO₂ and the one or more sources of Al₂O₃ comprise silicon and aluminum containing zeolites having a FAU framework structure, wherein preferably the one or more sources of SiO₂ and the one or more sources of Al₂O₃ consist of a silicon and aluminum containing zeolite having a FAU framework structure.
52. The process of any one of embodiments 16 to 51, wherein the solvent system is selected from the group consisting of optionally branched (C1-C4)alcohols, distilled water, and mixtures thereof, preferably from the group consisting of optionally branched (C1-C3)alcohols, distilled water, and mixtures thereof, more preferably from the group consisting of methanol, ethanol, distilled water, and mixtures thereof, wherein more preferably the solvent system comprises distilled water, wherein more preferably the solvent system consists of distilled water.
53. The process of any one of embodiments 16 to 52, wherein the mixture prepared in (1) and crystallized in (2) contains 5 wt.-% or less of phosphorous (P) calculated as the element and based on 100 wt.-% of the mixture prepared in (1), preferably 3 wt.-% or less, more preferably 1 wt.-% or less, more preferably 0.5 wt.-% or less, more preferably 0.1 wt.-% or less, more preferably 0.05 wt.-% or less, more preferably 0.01 wt.-% or less, more preferably 0.005 wt.-% or less, more preferably 0.001 wt.-% or less, more preferably 0.0005 wt. % or less, and more preferably 0.0001 wt.-% or less.
54. The process of any one of embodiments 16 to 53, wherein the mixture prepared in (1) comprises seed crystals, wherein the seed crystals comprise one or more zeolitic materials having the framework structure of the zeolitic material comprising SiO₂, B₂O₃ and Al₂O₃ in its framework structure obtained according to the process of any one of embodiments 15 to 59, wherein preferably the one or more zeolitic materials of the seed crystals is obtainable and/or obtained according to the process of any one of embodiments 15 to 59.
55. A zeolitic material having an AEI-type framework structure, preferably according to any one of embodiments 1 to 15, wherein the zeolitic material is obtainable and/or obtained according to the process of any one of embodiments 16 to 54.
56. A process for the treatment of NOₓ by selective catalytic reduction comprising
   (A) providing a gas stream containing one or more nitrogen oxides;
   (B) contacting the gas stream provided in step (A) with a zeolitic material according to any one of embodiments 1 to 15 and 55.
57. The process of embodiment 56, wherein the gas stream provided in (A) further comprises one or more reducing agents, wherein the reducing agent preferably comprises ammonia and/or urea.
58. The process of embodiment 56 or 57, wherein the gas stream provided in (A) comprises one or more waste gases, preferably one or more waste gases from one or more industrial processes, wherein more preferably the waste gas stream comprises one or more waste gas streams obtained in processes for producing adipic acid, nitric acid, hydroxylamine derivatives, caprolactame, glyoxal, methyl-glyoxal, glyoxylic acid or in processes for burning nitrogeneous materials, including mixtures of waste gas streams from two or more of said processes, wherein even more preferably the waste gas stream comprises one or more waste gas streams obtained in processes for producing adipic acid and/or nitric acid.
59. The process of any one of embodiments 56 to 58, wherein the gas stream provided in (A) comprises one or more waste gases from an internal combustion engine, preferably from a diesel engine or from a lean burn gasoline engine.
60. The process of any one of embodiments 56 to 59, wherein the contacting of the gas stream with the zeolitic material in (B) is conducted at a temperature comprised in the range of from 250 to 550° C., preferably of from 300 to 500° C., more preferably of from 325 to 450° C., more preferably of from 350 to 425° C., more preferably of from 380 to 420° C., and even more preferably of from 390 to 410° C.
61. Apparatus for the treatment of a gas stream containing NON, the apparatus comprising a catalyst bed provided in fluid contact with the gas stream to be treated, wherein the catalyst bed comprises a zeolitic material according to any one of embodiments 1 to 15 and 55.
62. The apparatus of embodiment 61, wherein the catalyst bed is a fixed bed catalyst or a fluidized bed catalyst, preferably a fixed bed catalyst.
63. The apparatus of embodiment 61 or 62, further comprising one or more devices provided upstream of the catalyst bed for injecting one or more reducing agents into the gas stream, wherein the reducing agent preferably comprises ammonia and/or urea.
64. Use of a zeolitic material according to any one of embodiments 1 to 15 and 55 as a molecular sieve, as an adsorbent, for ion-exchange, as a catalyst or a precursor thereof, and/or as a catalyst support or a precursor thereof, preferably as a catalyst or a precursor thereof and/or as a catalyst support or a precursor thereof, more preferably as a catalyst or a precursor thereof, more preferably as a catalyst for the selective catalytic reduction (SCR) of nitrogen oxides NOₓ; for the storage and/or adsorption of CO₂; for the oxidation of NH₃, in particular for the oxidation of NH₃ slip in diesel systems; for the decomposition of N₂O; as an additive in fluid catalytic cracking (FCC) processes; and/or as a catalyst in organic conversion reactions, preferably in the conversion of alcohols to olefins, and more preferably in methanol to olefin (MTO) catalysis; more preferably for the selective catalytic reduction (SCR) of nitrogen oxides NOₓ, and more preferably for the selective catalytic reduction (SCR) of nitrogen oxides NOₓ in exhaust gas from a combustion engine, preferably from a diesel engine or from a lean burn gasoline engine.

### EXPERIMENTAL SECTION

### Reference Example 1: Inductively Coupled Plasma (ICP)

Elemental analyses were performed on an inductively coupled plasma-atomic emission spectrometer (ICP-AES, Shimadzu ICPE-9000).

### Reference Example 2: Scanning Electron Microscopy (SEM)

FE-SEM images were obtained on a Hitachi S-5200 microscope operated at 1 kV.

### Reference Example 3: Determination of the X-Ray Diffractogram (XRD)

Powder X-ray diffraction (XRD) patterns were collected on a Rigaku Ultima Ill diffractometer using CuKa radiation (40 kV, 40 mA).

### Reference Example 4: Determination of the Mean Aspect Ratio and Mean Particle Size

For determining the aspect ratio of the primary crystals of the zeolitic materials, zeolite primary crystallites oriented perpendicular to the electron probe were selected manually in the SEM images for evaluation. Both accessible dimensions for a given crystal (i.e. width and height of the crystal) were measured and documented for each particle. The procedure was conducted on as many SEM images displaying different portions of the surface of the sample as necessary for obtaining values for at least 120 different particles, preferably for at least 150 different particles, and more preferably for at least 200 different particles. The mean value of the aspect ratio, i.e. the ratio of the width to the height of each particle, obtained for all of the measured particles constituted then the mean aspect ratio of the sample. The mean width (largest dimension) of the primary crystals which was obtained in the aforementioned manner constituted the mean particle size of the primary crystals of the sample.

### Reference Example 5: Synthesis of N,N-dimethyl-3,5-dimethylpiperidinium hydroxide (DMPOH)

First, 24 g of 3,5-dimethylpiperidine (TCl, 98%, cis-trans mixture) were mixed with 220 ml of methanol (Wako, 99.9%) and 42 g of potassium carbonate (Wako, 99.5%). Then, 121 g of methyl iodide (Wako, 99.5%) were added dropwise, and the resultant mixture maintained under reflux for 1 day. After evaporation to partially remove the methanol, chloroform was added and stirred, followed by filtration to remove potassium carbonate. This step was repeated to completely remove the methanol and potassium carbonate. Then, ethanol was added for recrystallization, and diethylether was added to precipitate the iodide salt. After filtration, the solid product was dried and mixed with hydroxide ion exchange resin (DIAION SA10AOH, Mitsubishi) and distilled water. After 1 day, the resin was removed by filtration and the DMPOH aqueous solution (35.1 wt. %) was obtained.

### Comparative Example 1: Preparation of a Zeolitic Material Having an AEI Type Framework Structure Using Tetraethylphosphonium as Templating Agent

First, tetraethylphosphonium hydroxide (TEPOH) aqueous solution was mixed with 8 M NaOH aqueous solution (Wako) and distilled water. Then, boric acid (Wako) was added to the above solution, with stirring for 1 h. Then, HY zeolite (CBV720 with Si/Al=15, Zeolyst) was added to the above solution, with stirring for 1 h. The molar composition of the resultant gel was 1 SiO₂: 0-0.2H3BO3:0.067 Al: 0.2 TEPOH: 0.1 NaOH:5H₂O. The thus prepared mother gel was crystallized in an autoclave at 170° C. for 5 days under tumbling condition (40 r.p.m.). The solid product was recovered by centrifugation, washed with distilled water, and dried overnight at 100° C. under air. As may be taken from the XRD of the materials obtained displayed in FIG. 1, zeolitic materials displaying the AEI framework-type structure were respectively obtained. The SEM images of the materials obtained is displayed in FIG. 3.

The as-synthesized SSZ-39 and [B, Al]-AEI zeolites (0.5 g) using TEPOH as OSDA were calcined at 600° C. in the flow of hydrogen/nitrogen mixture (H₂: 15 mL/min, N₂: 60 mL/min) for 6 h to remove the template.

The calcined Na-form zeolite (1 g) was ion-exchanged with 100 mL of 2.5 M NH₄NO₃ aqueous solution at 80° C. for 3 h twice. The solid product was recovered by filtration, washed with distilled water, dried at 100° C. under air, and calcined at 600° C. in air for 5 h to obtain the H-form zeolite.

The mean particle sizes of the zeolites obtained using no boron as well as samples obtained using an SiO₂:H₃BO₃ molar ratio of 20, 10, and 5 were respectively obtained according to the method of Reference Example 4. Thus the zeolites obtained using no boron as well as those obtained using an SiO₂:H₃BO₃ molar ratio of 20 and 10 displayed a mean particle size of 140 nm, respectively, whereas the zeolite obtained using an SiO₂:H₃BO₃ molar ratio of 5 displayed a mean particle size of 800 nm.

Thus, as may be taken from the results of the determination of the mean particle sizes which is reflected in the SEM images of the zeolitic materials in FIG. 3, larger crystal sizes are only obtained when using high amounts of boron in the starting gel. When using less boron or no boron at all in the starting gel, only very small crystals are obtained.

### Example 1: Preparation of a Zeolitic Material Having an AEI Type Framework Structure Using N,N-Dimethyl-3,5-Dimethylpiperidinium as Templating Agent

First, 0.7555 g DMPOH aqueous solution obtained according to Reference Example 5 was mixed with 0.82 g 8 M NaOH aqueous solution (Wako) and distilled water. Then, 0.033 g boric acid (Wako) was added to the above solution, with stirring for 1 h. Then, 0.6665 g HY zeolite (CBV760 with Si/Al=30, Zeolyst) was added to the above solution, with stirring for 1 h. The molar composition of the resultant gel was 1 SiO₂: 0.05H3BO3:0.033 Al: 0.155 DMPOH: 0.48 NaOH, wherein the H₂O:SiO₂ molar ratio of the gel was varied between 20 and 40. The thus prepared mother gels were crystallized in an autoclave at 150° C. for 3 days under tumbling condition (30 r.p.m.). The solid product was recovered by filtration, washed with distilled water, and dried overnight at 100° C. under air. As may be taken from the XRD of the materials obtained displayed in FIG. 2, zeolitic materials displaying the AEI framework-type structure were respectively obtained. The SEM images of the materials obtained is displayed in FIG. 4.

The as-synthesized SSZ-39 and [B, Al]-AEI zeolites using DMPOH as OSDA were then calcined at 600° C. in air for 6 h to remove the template.

The calcined Na-form zeolites (1 g) were ion-exchanged with 100 mL of 2.5 M NH₄NO₃ aqueous solution at 80° C. for 3 h twice. The solid product was recovered by filtration, washed with distilled water, dried at 100° C. under air, and calcined at 600° C. in air for 5 h to obtain the H-form zeolites.

The mean aspect ratios and mean particle sizes of the zeolites obtained using an H₂O:SiO₂ molar ratio of 20, 30, and 40 were respectively obtained according to the method of Reference Example 4. Thus the mean particle size of the zeolite obtained using an H₂O:SiO₂ molar ratio of 20 afforded a mean particle size of 1.5 μm and a mean aspect ratio of 4.3, the zeolite obtained using an H₂O:SiO₂ molar ratio of 30 afforded a mean particle size of 1.0 μm and a mean aspect ratio of 3.0, and the zeolite obtained using an H₂O:SiO₂ molar ratio of 40 afforded a mean particle size of 1.0 μm and a mean aspect ratio of 2.0.

Thus, as may be taken from the results of the determination of the mean particle sizes which is reflected in the SEM images of the zeolitic materials in FIG. 4, even with low amounts of boron in the starting gels, large crystal sizes may be achieved. Thus, compared to the results achieved according to Comparative Example 1, larger crystals containing a relatively high concentration of catalytically active Al-sites may be obtained compared to the larger crystals obtained according to Comparative Example 1, wherein isomorphous substitution of the Al sites with boron occurs to a far greater extent.

In addition to the aforementioned advantages, the inventive method allows the use of starting gels with a far greater amount of water compared to the starting gels according to Comparative Example 1. As a result, a better crystallinity may be achieved. Furthermore, the starting gels according to the inventive methods display a much higher degree of tolerance towards impurities due to the higher grade of dilution, as a result of with the inventive method allows for a recycling of the template and/or of non-reacted materials to a far greater extent than is possible when using a method according to Comparative Example 1.

Finally, the method of Comparative Example 1 requires an elaborate procedures for removal of the phosphorous-containing template, i.e. calcination under a reductive atmosphere, which nevertheless does not lead to a product which is entirely free of phosphorous-containing residues, whereas the inventive method allows for the quantitative removal of the organotemplate employed by simple calcination in air.

### Example 2: Preparation of a Zeolitic Material Having an AEI Type Framework Structure Using N,N-Dimethyl-3,5-Dimethylpiperidinium as Templating Agent

Zeolitic materials having an AEI type framework structure were prepared according to a procedure based on the method of Example 1 employing N,N-dimethyl-3,5-dimethylpiperidinium as templating agent and starting gel compositions of 1 SiO₂: 0-0.2H3BO3:0.033 Al: 0.155 DMPOH: 0.1 NaOH: 20-31H₂O, wherein the Si:B molar ratio employed in the starting gel was varied between 5 and 20. As may be taken from the XRD of the materials obtained displayed in FIG. 5, zeolitic materials displaying the AEI framework-type structure were respectively obtained. The SEM images of the materials obtained is displayed in FIG. 6.

Elemental analysis of the resulting zeolitic materials via ICP afforded the results displayed in the following table.

TABLE 1
Molar ratios of the starting gels and elemental analysis via ICP
of the zeolitic materials obtained according to Example 2.

| | | | | Analysis of product via ICP | | | |
|---|---|---|---|---|---|---|---|
| Starting gel | | | | | | Si/ | |
| Template | Si:B | NaOH:Si | H2O:Si | Si:B | Si:Al | (Al + B) | Al:B |
| DMPOH | 20 | 0.48 | 31 | 141 | 8.7 | 8.2 | 16.2 |
| DMPOH | 10 | 0.48 | 20 | 134 | 8.8 | 8.3 | 15.2 |
| DMPOH | 5 | 0.60 | 20 | n.a. | n.a. | n.a. | n.a. |

As may be taken from the SEM images of the zeolitic materials in FIG. 6, upon increasing the amount of boron in the starting gel, a further increase in the crystal size of the resulting zeolitic materials may be achieved compared to Example 1, which employed an Si:B molar ratio of 20 in the starting gel. However, as may be taken from a comparison with the results displayed in FIG. 3 for Comparative Example 1, far less boron is required in the inventive process for obtaining crystal sizes comparable to those obtained according to the comparative example. Thus again, as indicated above in the discussion of the results of Example 1, even with relatively low amounts of boron in the starting gels, large crystal sizes may be achieved containing a relatively high concentration of catalytically active Al-sites compared to the larger crystals obtained according to Comparative Example 1, wherein isomorphous substitution of the Al sites with boron occurs to a far greater extent.

### BRIEF DESCRIPTION OF THE FIGURES

FIG. 1: shows the XRD patterns of as-made [B, Al]-AEI zeolites obtained according to Comparative Example 1.

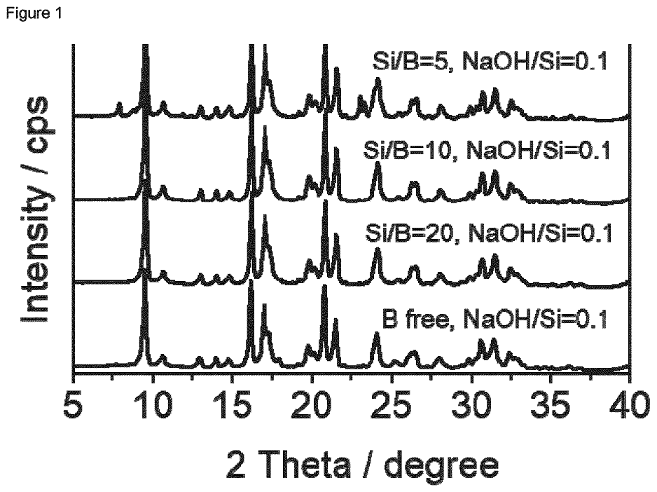

FIG. 2: shows the XRD patterns of the as-made [B, Al]-AEI zeolites obtained according to Example 1.

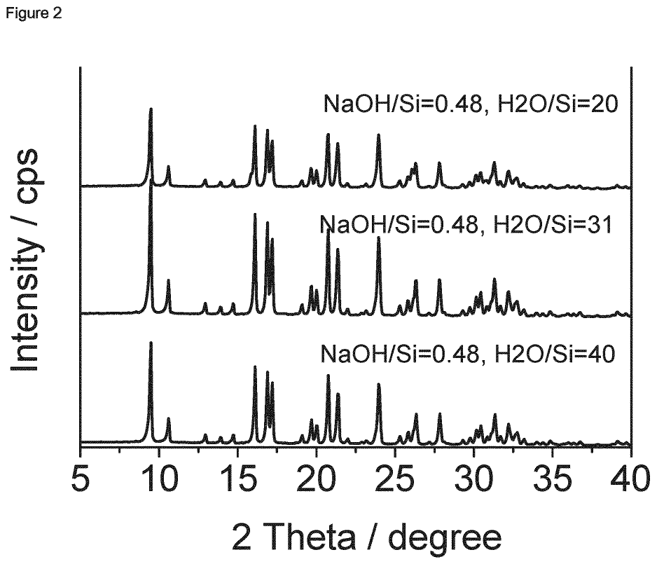

FIG. 3: shows the SEM images of as-made [B, Al]-AEI zeolites obtained according to Comparative Example 1.

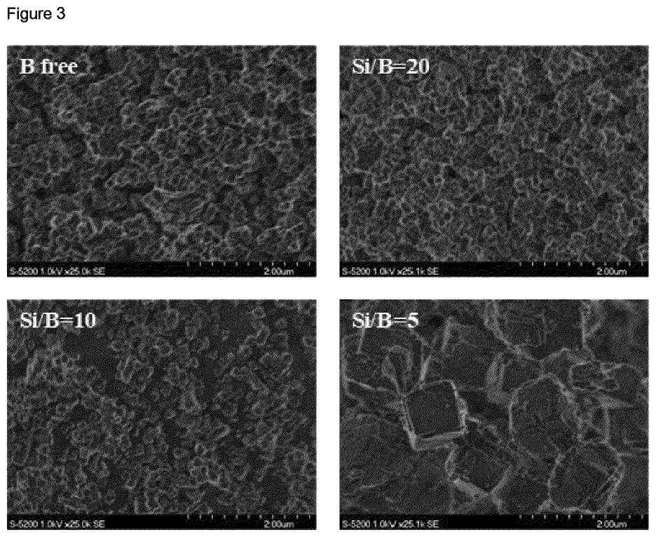

FIG. 4: shows the SEM images of as-made [B, Al]-AEI zeolites obtained according to Example 1.

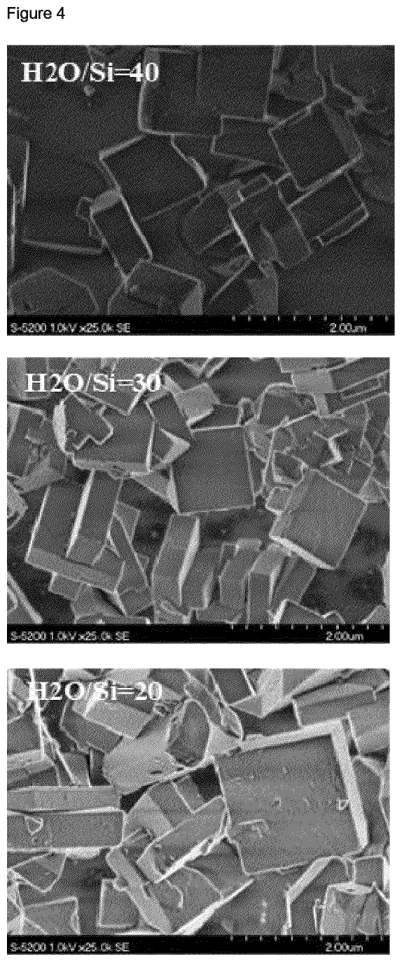

FIG. 5: shows the XRD patterns of as-made [B, Al]-AEI zeolites obtained according to Comparative Example 2.

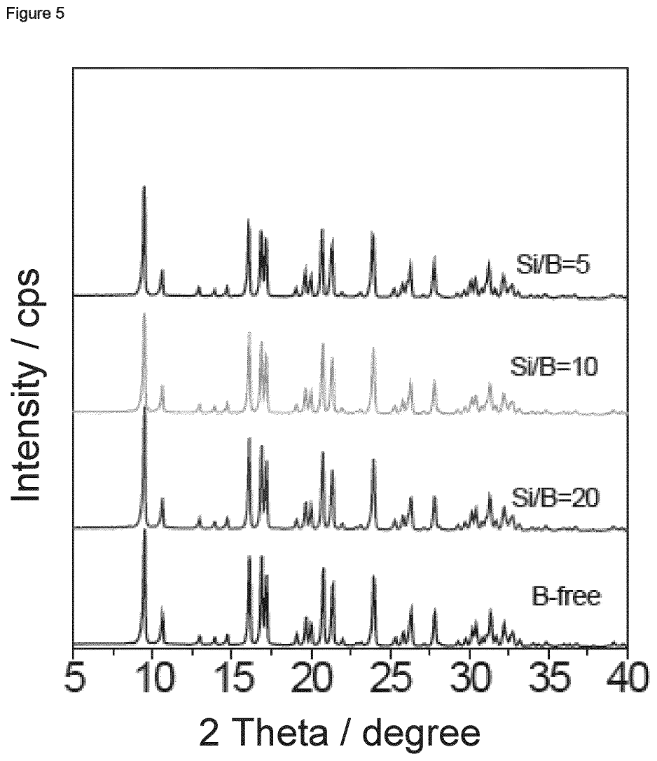

FIG. 6: shows the SEM images of as-made [B, Al]-AEI zeolites obtained according to Example 2.

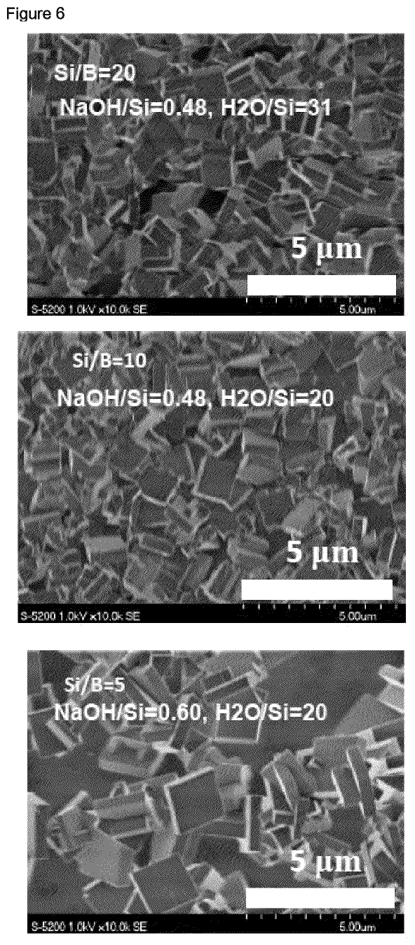

### CITED LITERATURE

U.S. Pat. No. 5,958,370
Moliner, M. et al. in Chem. Commun. 2012, 48, pages 8264-8266
Maruo, T. et al. in Chem. Lett. 2014, 43, page 302-304
Martín, N. et al. in Chem. Commun. 2015, 51, 11030-11033
Dusselier, M. et al. in ACS Catal. 2015, 5, 10, 6078-6085
US 2015/0118150 A1
WO 2016/149234 A1
Ransom, R. et al. in Ind. Eng. Chem. Res. 2017, 56, 4350-4356
WO 2018/113566 A1
JP2018087105A

1-15. (canceled)

16. A zeolitic material having an AEI-type framework structure comprising SiO₂, Al₂O₃ and B₂O₃, wherein the Al:B molar ratio of the zeolitic material, is comprised in the range of from 10 to 50, wherein the Si:B molar ratio of the zeolitic material is in the range of from 180 to 220,
wherein the zeolitic material displays an Si:(Al+B) molar ratio of the zeolitic material, which is comprised in the range of from 5 to 10; wherein the Si:Al molar ratio of the zeolitic material is in the range of from 6 to 25, wherein the mean particle size of the primary crystals of the zeolitic material is in the range of from 0.5 to 4.0 μm, and wherein the primary crystals of the zeolitic material display a mean aspect ratio of from 1.4 to 5.0.

17. The zeolitic material of claim 16, wherein the zeolitic material comprises one or more metal cations M selected from the group consisting of Sr, Zr, Cr, Mo, Fe, Co, Ni, Cu, Zn, Ru, Rh, Pd, Ag, Os, Ir, Pt, Au, La, Ce, Pr, Nd, Sm, Eu, Gd, Tb, Dy, Ho, Er, Tm, Yb, Lu, Y, Sc, and mixtures of two or more thereof.

18. The zeolitic material of claim 16, wherein the zeolitic material having an AEI-type framework structure is selected from the group consisting of SSZ-39, SAPO-18, and SIZ-8, including mixtures of two or more thereof.

19. A process for the preparation of the zeolitic material having an AEI-type framework structure comprising SiO₂, Al₂O₃ and B₂O₃ of claim 16, the process comprising:
(1) preparing a mixture comprising one or more organotemplates as structure directing agents, one or more sources of SiO₂, one or more sources of B₂O₃, one or more sources of Al₂O₃, optionally seed crystals, and a solvent system; wherein the one or more sources of SiO₂ and the one or more sources of Al₂O₃ comprise silicon and aluminum containing zeolites having a FAU frame-work structure;
wherein the molar ratio of Si:B of the silicon to the boron, calculated as the element, respectively, in the mixture prepared according to (1) is in the range of from 4 to 25,
wherein the molar ratio of Si:Al of the silicon to the boron, calculated as the element, respectively, in the mixture prepared according to (1) is in the range of from 15 to 50,
(2) heating the mixture obtained in (1) for crystallizing a zeolitic material comprising SiO₂, B₂O₃ and Al₂O₃ in its framework structure from the mixture;
wherein the one or more organotemplates is selected from the group consisting of N,N-di(C₁-C₂)alkyl-3,5-di(C₁-C₂)alkylpiperidinium compounds, N,N-di(C₁-C₂)alkyl-2,6-di(C₁-C₂)alkylpiperidinium compounds, and mixtures of two or more thereof.

20. The process of claim 19, wherein the mixture prepared in (1) comprises seed crystals, wherein the amount of seed crystals comprised in the mixture prepared in (1) is in the range of from 0.1 to 15 weight-% based on 100 weight-% of Si in the mixture calculated as SiO₂.

21. A zeolitic material having an AEI-type framework structure, wherein the zeolitic material is obtainable and/or obtained according to the process of claim 19.

22. A process for the treatment of NOₓ by selective catalytic reduction comprising
(A) providing a gas stream containing one or more nitrogen oxides;
(B) contacting the gas stream provided in step (A) with a zeolitic material according to claim 16.

23. Apparatus for the treatment of a gas stream containing NOₓ, the apparatus comprising a catalyst bed provided in fluid contact with the gas stream to be treated, wherein the catalyst bed comprises a zeolitic material according to claim 16.

24. Use of a zeolitic material according to claim 16 as a molecular sieve, as an adsorbent, for ion-exchange, as a catalyst or a precursor thereof, and/or as a catalyst support or a precursor thereof; for the storage and/or adsorption of CO₂; for the oxidation of NH₃, in particular for the oxidation of NH₃ slip in diesel systems; for the decomposition of N₂O; as an additive in fluid catalytic cracking (FCC) processes; and/or as a catalyst in organic conversion reactions.
